(19) United States
(12) Patent Application Publication
(10) Pub. No.: US 2003/0192480 A1
(43) Pub. Date: Oct. 16, 2003

(54) Feeding stand for pet food package

(76) Inventor: Harold Bennett, St. Joseph, MO (US)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(21) Appl. No.: 10/123,718

(22) Filed: Apr. 16, 2002

(51) Int. Cl. A01K 1/10; A01K 5/00; A01K 39/00

(52) U.S. Cl. 119/61

(57) ABSTRACT

A feeding stand for a packaged food product includes a body comprising a bowl-shaped base defining a dish receptacle therein, said receptacle comprising a first rim support having a first diameter for supporting the dish, and a second rim support having a second diameter, said second diameter less than said first diameter.

### BACKGROUND OF THE INVENTION

This invention relates generally to feeding bowls, and, more particularly, to a feeding stand for a packaged food product.

Regular feeding of household animals, such as dogs and cats, can be a messy and time consuming task. Conventionally, domestic animals are fed by placing a portion of pet food from a bag, can, or other container into a feeding bowl for consumption by the pet. Like other food serving containers, pet food bowls require regular washing to prevent unpleasant odors and insect infestation, as well as to maintain an acceptable animal hygiene. Washing pet food bowls, however, is not an enjoyable task, and, for obvious reasons, pet food bowls are often cleaned separately from household dishes with separate washing tools, rags, etc. Cleaning of the bowl is more difficult if not promptly cleaned after an animal is fed, especially when wet pet foods are fed to the animal. Busy pet owners, however, do not always have time to immediately clean up feeding bowls after feeding their pets.

Additionally, pet foods, particularly wet foods, are typically served into a feeding bowl with a utensil. The serving utensil must be cleaned and maintained in addition to the feeding bowl after the animal is fed. Still further, it is sometimes difficult for owners to feed a pet without themselves or their clothes becoming soiled by the pet food. At times, this can be a considerable inconvenience to busy pet owners.

The inconveniences of pet feeding bowls are experienced daily, and sometimes more than once a day, by a large number of pet owners.

### BRIEF DESCRIPTION OF THE INVENTION

In one aspect, a feeding stand for a packaged food product is provided. The stand comprises a body comprising a bowl-shaped base defining a dish receptacle therein, said receptacle comprising a first rim support having a first diameter for supporting the dish, and a second rim support having a second diameter, said second diameter less than said first diameter.

In another aspect, a feeding stand for a pre-packaged pet food dish including first, second and third portions is provided. The stand comprises a body defining a dish receptacle therein, said receptacle comprising an outer rim support having a first diameter for receiving the first portion of the dish, an intermediate rim support having a second diameter for receiving the second portion of the dish, and an inner rim support having a third diameter for receiving the third portion of the dish, said first diameter greater than said second diameter, said second diameter greater than said third diameter.

In another aspect, a pet feeding apparatus is provided. The apparatus comprises a pre-packaged pet food dish, and a feeding stand comprising a dish receptacle, said dish extending through said dish receptacle, said receptacle configured to lockably engage to said dish.

In another aspect, a pet feeding apparatus is provided. The apparatus comprises a pre-packaged, disposable pet food dish comprising a peel back lid, and a feeding stand configured to lockably engage to said dish and to position said dish so that said lid is substantially flush with a top surface of said base.

In another aspect, a method for hygienic feeding of a pet animal is provided. The method comprises providing a pet food container with a removable lid, the container including a pet food product, providing a feeding stand configured to lockably receive the container, inserting the container into the stand, removing the container lid to expose the food product, and serving the food product to the animal while the container is located in the stand.

In another aspect, a method for hygienic dispensing of a food product is provided. The food product is packaged in a container with a removable lid and the method utilizes a feeding stand comprising a receptacle to lockably receive the container. The method comprises locking the container into the stand receptacle, removing the container lid to expose the food product, and serving the food product.

### BRIEF DESCRIPTION OF THE DRAWINGS

FIG. 1 is a perspective view of a pet feeding apparatus.

FIG. 2 is a cross sectional schematic view of the apparatus shown in FIG. 1.

FIG. 3 is a perspective view-of the stand shown in FIGS. 1 and 2.

### DETAILED DESCRIPTION OF THE INVENTION

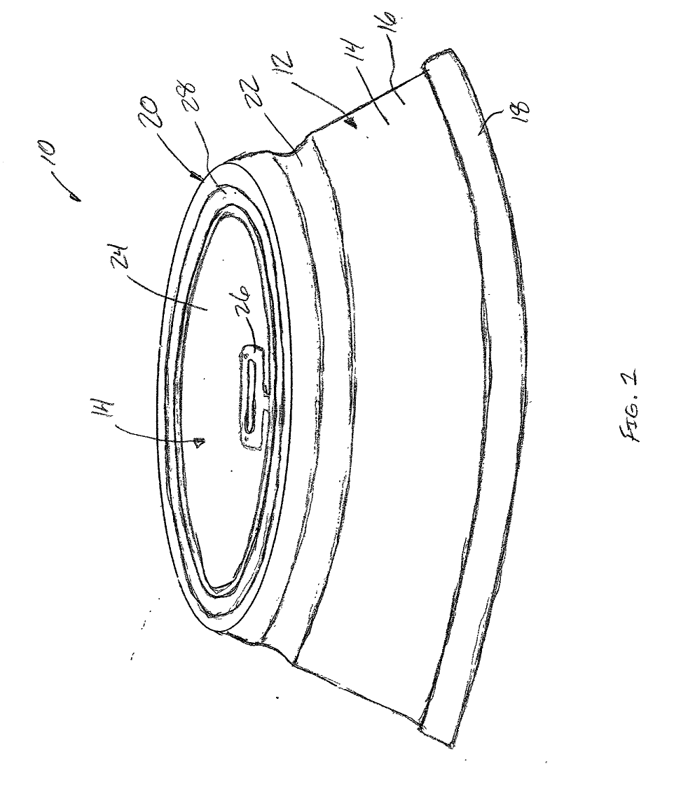

FIG. 1 is a perspective view of a feeding apparatus 10 including a feeder base or stand 12 and a packaged food dish 14 coupled thereto that has been found particularly advantageous for feeding pets. As explained in detail below, feeding apparatus 10 is well suited for convenient feeding of dogs and cats, for example, while eliminating time consuming cleanup and associated difficulties of conventional animal feeding bowls. It is recognized that feeding apparatus 10 may be utilized for feeding of other animals as well, and it is further contemplated that the feeding apparatus described herein may find general utility in serving of foodstuffs for human consumption as well. Therefore, the illustrative embodiments and contexts described herein are set forth for purposes of illustration rather than by way of limitation.

Feeder stand 12 includes a body 14 including an outwardly sloping side surface 16 extending between a footing 18 and a head portion 20. As described further below, stand head portion 20 includes a packaged dish receptacle (not shown in FIG. 1) that receives and engages dish 14 to stand 12 with locking engagement for secure positioning of dish 14 for feeding of a pet. As illustrated in FIG. 1, feeding stand 12 has a continuous curved side surface 16 extending outwardly from stand head portion 20 to stand footing 18 to provide stand 12 with a generally frustaconical or inverted bowl shape. That is, stand outer surface 16 of body 14 generally increases in diameter from stand head portion 20 to stand footing 18 in a funnel or cone shaped fashion. It is contemplated, however, that other shapes of feeder stand body 14 may be employed in alternative embodiments without departing from the scope of the present invention, including but not limited to rectangular shapes, oval shapes, and shapes including both straight sides and curved sides.

Stand body 14, in one embodiment, is integrally formed from a known sturdy, durable material according to a known method. In a particular embodiment, body 14 is fabricated from aluminum and finished with a rugged, polished surface. In the illustrated embodiment, stand body 14 includes an inwardly depressed band 22 separating body head portion 20 from body side surface 14. It is understood however, that a variety of other materials are suitable for use in fabricating feeding stand 12 according to known methods and techniques, including but not limited to molded plastic materials.

Also in an illustrative embodiment, footing 18 is separately fabricated from a known resilient material, such as rubber in a particular embodiment, and is fitted onto a lower portion of stand side surface 16. Footing 12 substantially prevents stand 12 from sliding across a floor when a pet is feeding, and prevents nicks, scratches and scuffs to the floor surface as stand 12 is used. In alternative embodiments, footing 18 is fabricated from other known materials in lieu of rubber, such as known plastic materials for example, and in a further alternative embodiment, footing 18 may be fabricated integrally with stand body 14.

Packaged food dish 14, in one embodiment, is a container including a pre-packaged food. The container is securely coupled to feeding stand 12. When used as a pet feeding device, dish 14 contains a serving portion of a known pet food product, and the shape of the container facilitates interlocking engagement with feeder stand 14. As illustrated in FIG. 1, packaged food dish 14 includes a substantially circular peel back lid 24 that is easily removed with a tab handle 26 as is known in the art. Dish lid 24 is positioned substantially flush with a top surface 28 of feeding stand head 20, and when food dish lid 24 is removed, the food product in dish 14 is exposed for consumption.

Feeder stand head portion 20 forms a slight rim 28 around food dish 14 to contain the food product as it is consumed. After consumption, food dish 14 is removed from feeding stand 12 and disposed of or recycled. Exemplary pet food dish packages having such features are commercially available from Friskies Petcare Company, Inc. of Glendale Calif. It is noted, however, that packaged food dish 14 may contain a wide variety of food product, including human food, in alternative embodiments.

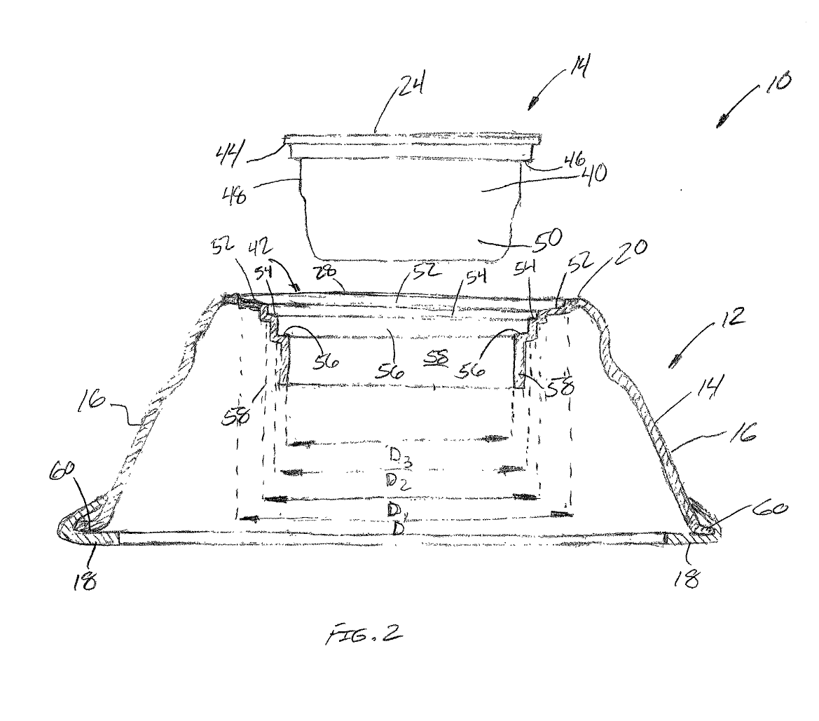

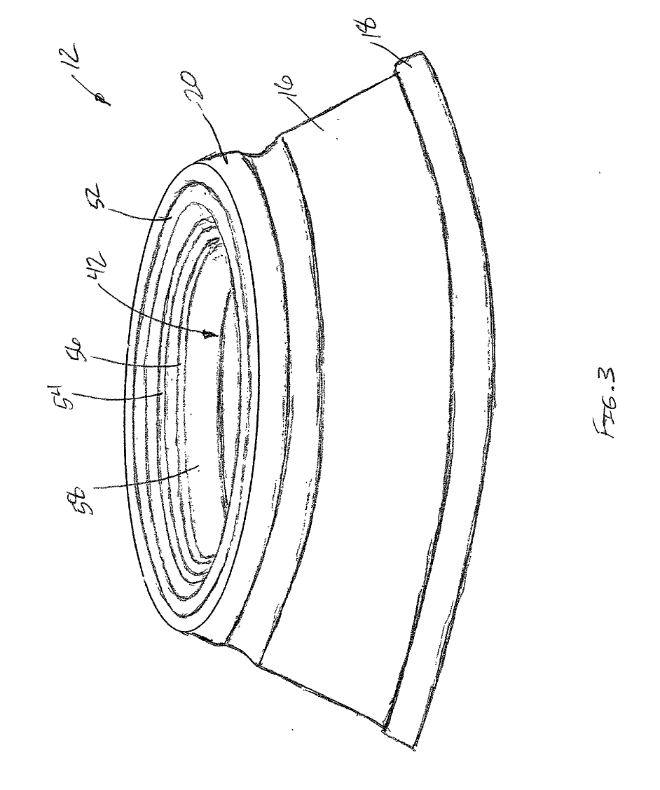

FIG. 2 is a cross sectional schematic view of feeding apparatus 10 illustrating packaged food dish 14 located above feeding stand 12 (shown in cross section) so that the interlocking engagement of dish 14 and stand 12 may be seen, and FIG. 3 is a perspective view of feeding stand 12 with dish 14 removed so that features of stand 12 may be better appreciated.

Packaged food dish 14 includes a container body 40 forming an enclosure for the food product (e.g., pet food product) beneath removable lid 24. Container body 40 includes several distinct portions that cooperate with a dish receptacle 42 formed in feeder stand body 14 within stand body head portion 20. Specifically, container body 40 includes a top rim 44 to which removable lid 24 is attached, a nested cover rim 46 extending from top rim 44, and a stand engagement section 48 depending downwardly from cover rim 46. In an exemplary embodiment, stand engagement section 48 is substantially cylindrical in shape, although it is appreciated that other shapes of engagement section 48 may be employed in alternative embodiments. Container body 40 further includes a rounded lower end section 50 depending downwardly from stand engagement section 48.

Container body 40 is sized and dimensioned to create a specified volume therein to contain a predetermined portion or serving of food product. It is contemplated that the dimensions of food dish 14 may vary for different types of food product (e.g., pet food formulations for dogs or cats and dry or wet food formulations). It is further noted that dimensions of food dish 14 may vary according to recommended serving size of the food product (e.g., pet food serving for particular sizes, ages or breed of a particular animal). Dimensions of dish rims 44, 46, and dish engagement section 48 are selected in conjunction with dish receptacle 42 of feeder stand 12.

Feeder stand dish receptacle 42 is generally complementary in shape to pet food container body 42 to facilitate an interlocking arrangement described below. Specifically, feeder dish receptacle 40 includes a slightly sloped dish rim surface 52 depending inwardly (i.e., toward a center of stand 10) from a top surface of stand head portion 20. A substantially horizontal or level dish lid rim support 54 depends inwardly from dish rim surface 52, and a dish cover rim support 56 depends inwardly from dish lid rim 54. A generally cylindrical container body support 58 depends inwardly from cover rim 56. Each of cover rim surface 52, dish lid rim support 54, and cover rim support 56 in the illustrated embodiment are substantially annular surfaces formed into dish receptacle 42, and are connected by substantially vertical support sections formed into dish receptacle 42.

Moreover, as best illustrated in FIG. 2, dish rim surface 54 of feeder stand dish receptacle extends at a first diameter D, dish lid rim support extends at an inner diameter D₁, dish cover rim support 56 extends at an inner diameter D₂, and container body support extends at an inner diameter D₃. Each diameter D, D₁, D₂, D₃, is successively smaller than the preceding diameter, thereby providing dish receptacle 42 with an inwardly stepped configuration. By selecting diameter values of D₁, D₂, D₃ approximately equal to or slightly less than respective outer diameters of food dish rims 44, 46, and dish engagement section 48, dish 14 may be securely received in feeder stand dish receptacle 42 with an interference fit. Secure interlocking engagement of dish 14 and dish receptacle 42 is therefore obtained when container body 40 is inserted into dish receptacle 42 while allowing food dish 14 to be removed from feeder stand 12 without excessive difficulty.

While apparatus 10 is illustrated and described with specific shapes of food dish 14 and complementary-shaped stand dish receptacle 42, it is understood that other complimentary shapes may be employed to achieve interlocking engagement of dish 14 and feeder stand 12.

Footing 18 is fitted over flared ends 60 of stand body outer surface 16. Footing 18 extends over a lower outer circumference of stand body 14, thereby stabilizing stand 12 and preventing stand 12 from sliding over a smooth flat surface, such as a floor or tabletop surface when stand 12 is used.

Dish 14 may be engaged to feeder stand 12 by positioning dish lower end 50 within receptacle 42 and lowering dish into and through receptacle 42. When dish engagement section 48 contacts container body support 58, some force must be exerted in a downward direction (i.e., toward footing 18) to fully engage dish 24 to receptacle 42 with an interference fit. Once fully engaged, cover lid rim 44 rests upon dish receptacle dish lid support 54, dish cover rim 46 rests upon dish cover rim support 56, dish engagement section 48 is engaged to and surrounded by container body support 58, and dish lower end 50 extends through stand container body support 58. As such, dish 14 is supported and retained in both vertical and horizontal axes, and apparatus 10 may be picked up, moved, and even turned upside down without dish 14 dislodging from stand 12. By removing lid 24 from dish 14 after dish 14 is engaged to stand 12, the food product in dish 14 is ready for consumption. Pet food may therefore be served without external utensils and in a reduced time in comparison to conventional feeding bowls.

A user may remove dish 14 from feeding stand 12 by turning apparatus 10 upside down, engaging dish lower end 50 with a thumb of each hand, and exerting a force on dish lower end 48 toward stand body head 20 until dish 14 is dislodged and ejected from dish receptacle 42. Dish 42 may be ejected into a garbage can or recycling bin without touching dish 14 from the top side where food product was consumed. By attaching another packaged food dish 14 into stand 12, and removing lid 24, more food product may be consumed.

By now it should be appreciated that food product can be served and dispensed quickly and conveniently with feeding apparatus 10 in a reduced period of time and with little to no cleanup either before or after food is consumed by virtue of removable food package 14. The food product need not be transferred from an external container to a location where it may be served, but is rather served directly from a packaged container. Serving utensils are substantially eliminated as the product may be consumed substantially from dish 14. Overfeeding is substantially eliminated with predetermined sizes of food dish packages 14, and feeder stand 12 is stable to prevent tips and spills during food consumption. Feeding apparatus is therefore will suited for hygienic feeding of pets.

While the invention has been described in terms of various specific embodiments, those skilled in the art will recognize that the invention can be practiced with modification within the spirit and scope of the claims.

What is claimed is:

1. A feeding stand for a packaged food product, said stand comprising:
a body comprising a bowl-shaped base comprising a dish receptacle therein, said receptacle comprising:
a first rim support having a first diameter for supporting the dish; and
a second rim support having a second diameter, said second diameter less than said first diameter.

2. A feeding stand in accordance with claim 1 further comprising a third rim support having a third diameter, said third diameter less than said second diameter.

3. A feeding stand in accordance with claim 1 wherein at least one of said first rim and said second rim supports is substantially annular.

4. A feeding stand in accordance with claim 1 wherein said rim supports are configured to couple said dish to said receptacle.

5. A feeding stand for a pre-packaged pet food dish including first, second and third portions, said stand comprising:
a body defining a dish receptacle therein, said receptacle comprising:
an outer rim support having a first diameter for receiving the first portion of the dish;
an intermediate rim support having a second diameter for receiving the second portion of the dish; and
an inner rim support having a third diameter for receiving the third portion of the dish, said first diameter greater than said second diameter, said second diameter greater than said third diameter.

6. A feeding stand in accordance with claim 5 wherein at least one of said outer rim support, intermediate rim support, and inner rim support is substantially annular.

7. A feeding stand in accordance with claim 6 wherein all of said rim supports are substantially annular.

8. A feeding stand in accordance with claim 5 wherein said outer, intermediate and inner rim supports are configured to attach the dish to said receptacle.

9. A pet feeding apparatus comprising:
a pre-packaged pet food dish; and
a feeding stand comprising a dish receptacle, said dish extending through said dish receptacle, said receptacle configured to lockably engage said dish.

10. A pet feeding apparatus in accordance with claim 9 wherein said stand comprises a body comprising a dish receptacle therein, said receptacle having a stepped configuration.

11. A pet feeding apparatus in accordance with claim 10 wherein said dish receptacle comprises an outer rim support and at least one inner rim supporting and retaining said dish stationary to said receptacle.

12. A pet feeding apparatus in accordance with claim 11 wherein said outer rim support is substantially annular.

13. A pet feeding apparatus in accordance with claim 12 wherein said dish receptacle further comprises a third rim support positioned intermediate said outer rim support and said inner rim.

14. A pet feeding apparatus in accordance with claim 11 wherein said dish comprises a peel back lid.

15. A pet feeding apparatus in accordance with claim 14 wherein said lid is substantially flush with a top surface of said stand when said dish is coupled to said stand.

16. A pet feeding apparatus comprising:
a pre-packaged, disposable pet food dish comprising a removable lid; and
a feeding stand configured to lockably engage said dish and to position said dish so that said lid is substantially flush with a top surface of said base.

17. A pet feeding apparatus in accordance with claim 16 wherein said stand comprises a base comprising a receptacle therein for receiving said dish, said receptacle and said dish dimensioned to create an interference fit between said dish and said receptacle.

18. A pet feeding apparatus in accordance with claim 17 wherein said dish receptacle comprises a stepped configuration having three portions.

19. A pet feeding apparatus in accordance with claim 18 wherein at least one of said portions is substantially annular.

20. A pet feeding apparatus in accordance with claim 17 wherein said dish comprises at least three portions inwardly extending from one another.

21. A method for hygienic feeding of a pet animal, the method comprising:
providing a pet food container with a removable lid, the container including a pet food product;
providing a feeding stand configured to lockably receive the container;
inserting the container into the stand;
removing the container lid to expose the food product; and
serving the food product to the animal while the container is located in the stand.

22. A method for hygienic dispensing of a food product, the food product packaged in a container with a removable lid, the method utilizing a feeding stand comprising a receptacle to lockably receive the container, said method comprising:
locking the container into the stand receptacle;
removing the container lid to expose the food product; and
serving the food product.

23. A method in accordance with claim 22 wherein the food product is a pet food.

24. A method in accordance with claim 23 wherein the food product is a wet pet food.
